(19) United States
(12) Patent Application Publication
(10) Pub. No.: US 2021/0290476 A1
(43) Pub. Date: Sep. 23, 2021

(54) Portable foldable wall-mount massage device

(71) Applicant: Jonathan Martin, New Port Richey, FL (US)

(72) Inventor: Jonathan Martin, New Port Richey, FL (US)

(21) Appl. No.: 17/206,246

(22) Filed: Mar. 19, 2021

Related U.S. Application Data
(60) Provisional application No. 62/993,102, filed on Mar. 23, 2020.

(51) Int. Cl. A61H 7/00

(52) U.S. Cl. CPC A61H 7/002; A61H 2201/013; A61H 2201/1253; A61H 2205/081; A61H 2201/0161; A61H 2201/0126; A61H 2201/0157

(57) ABSTRACT

The disclosed invention is a compact, folding, expandable, wall-mount massage device. The device has two primary configurations: the first is a long, collapsed shape for storage and travel; the second is a shorter, wider, expanded shape for use. The primary components of the device are: a massage element, shown as a sphere in the drawings; and a frame, the frame supporting the massage element during use. The frame includes a central column, surrounded by one or more folding support legs/stabilizing legs. In the collapsed position the folding legs lay near or against the central column, thus reducing the size of the device. In an in-use, or expanded position, the collapsing leg supports move outward, resting against the base of the central column. The result is a wide base that protrudes from the central column in multiple directions.

### RELATED APPLICATIONS

This application claims priority to provisional application No. 62/993,102, titled Portable foldable wall-mount massage device, filed Mar. 23, 2020.

### FIELD

This invention relates to the field of massage devices and more particularly to a portable massage device.

### BACKGROUND

Massage of muscles, facia, and nerves has long been understood to provide many therapeutic benefits. In addition, many individuals require regular massage to address knotted muscles, thus increasing flexibility and reducing pain.

Some body parts can be can be self-massaged. For example, the hands and feet. But other parts of the body, such as the back, shoulders, buttocks, and legs, are difficult for a user to massage on their own.

Thus, massage devices exist to help users massage areas of the body that are difficult to reach.

The need for massage can occur at any time, whether at home or traveling.

In order to be prepared, it is helpful for a user to have a device on their person. Specifically, a device that can travel with the user, being compact for travel and expandable for use.

What is needed is a device that can be take on a compact shape for travel, and a sturdy shape for use, the device helping a user massage a hard-to-reach area.

### SUMMARY

The disclosed invention is a compact, folding, expandable, wall-mount massage device. The device has two primary configurations: the first is a long, collapsed shape for storage and travel; the second is a shorter, wider, expanded shape for use.

The primary components of the device are: a massage element, shown as a sphere in the drawings; and a frame, the frame supporting the massage element during use.

The frame includes a central column, surrounded by one or more folding support legs/stabilizing legs. In the collapsed position the folding legs lay near or against the central column, thus reducing the size of the device.

In an in-use, or expanded position, the collapsing leg supports move outward, resting against the base of the central column. The result is a wide base that protrudes from the central column in multiple directions.

By protruding from the column in multiple directions, the device resists rocking, thus creating a sturdy platform. This allows the user to press against the massage element while the massage element remains largely stationary.

Downward force by the user is carried through the central column, for example pressure against the massage element perpendicular to the wall. Torque created by the user sliding against the massage element is carried by the support legs down to the base. From the base the force is carried to the suction cup assembly, and then passed to the supporting surface, for example, a wall.

The supporting legs include multiple hinges. The hinges allow the supporting legs to move to a long, collapsed position and a wider expanded position. In the disclosed embodiment the supporting legs include three sets of hinges: an upper hinge, a middle hinge, and a lower hinge.

The upper folding leg is attached to the central column by the upper hinge, and to the lower folding leg by the middle hinge.

The lower folding leg is connected to the central support, or column, by the lower hinge.

A suction cup assembly affixes the portable foldable wall-mount massage device to a supporting surface, such as a wall. The suction cup is affixed to a suction cup threaded rod, around which is threaded a suction cup compression ring.

After affixing the suction cup to a surface, the suction cup compression ring is threaded downward, pressing against the suction cup to increase its adhesion.

The suction cup threaded rod also attaches to the base.

The massage element is shown as a sphere, but can be many other shapes. For example, a cone, a flat disc, mushroom-shaped, and so forth.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side view of the expanded state of the portable folding massage device.

FIG. 2 illustrates a bottom isometric view of the collapsed state of the portable folding massage device.

FIG. 3 illustrates a top isometric view of the expanded state of the portable folding massage device.

FIG. 4 illustrates an exploded view of the portable folding massage device.

FIG. 5 illustrates a cross-sectional view of the expanded state of the portable folding massage device.

FIG. 6 illustrates a cross-sectional view of the collapsed state of the portable folding massage device.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

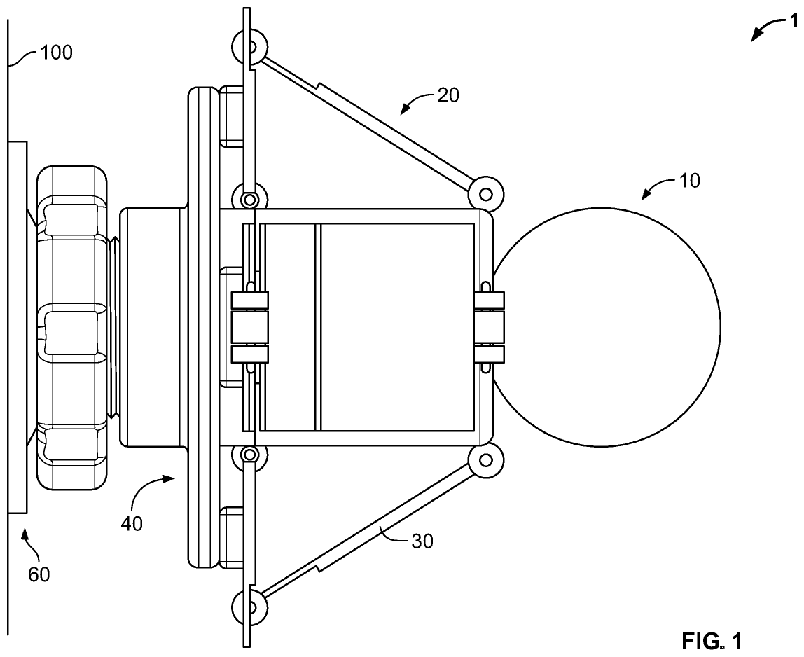

Referring to FIG. 1, a side view of the expanded state of the portable folding massage device is shown.

The portable foldable wall-mount massage device 1 includes the primary elements of a massage element 10, frame 20 with folding legs 30, base 40, and suction cup assembly 60.

The portable foldable wall-mount massage device 1 removably affixes to a supporting surface 100, such as a wall.

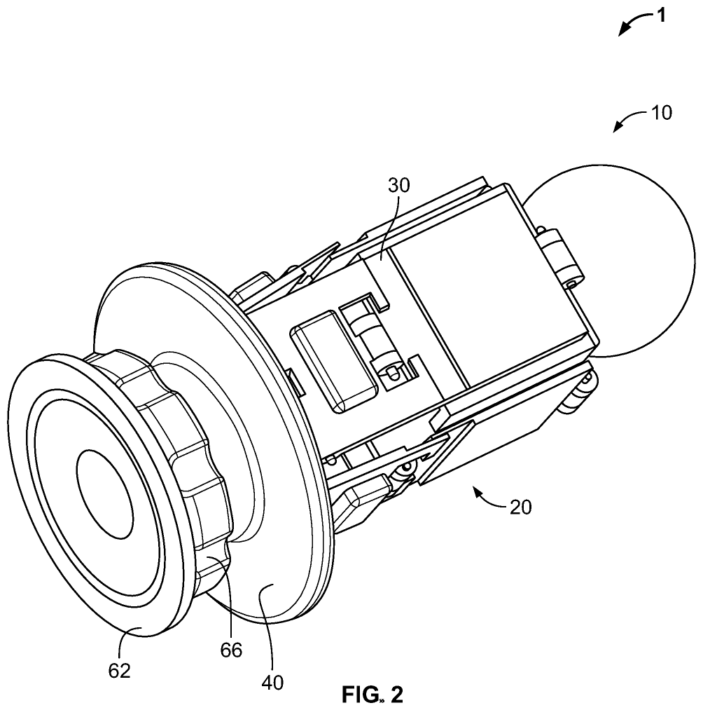

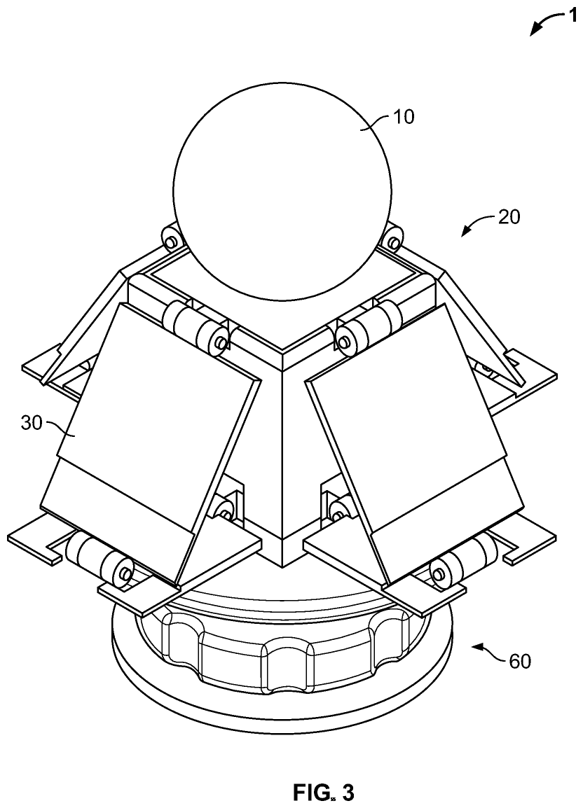

Referring to FIGS. 2 and 3, a bottom and isometric view of the collapsed state of the portable folding massage device are shown.

The portable foldable wall-mount massage device 1 is shown in its portable, collapsed position.

Again shown are the primarily elements of a massage element 10, frame 20 with folding legs 30, base 40, and suction cup assembly 60. The suction cup assembly 60 is shown with suction cup 62 and suction cup compression ring 66.

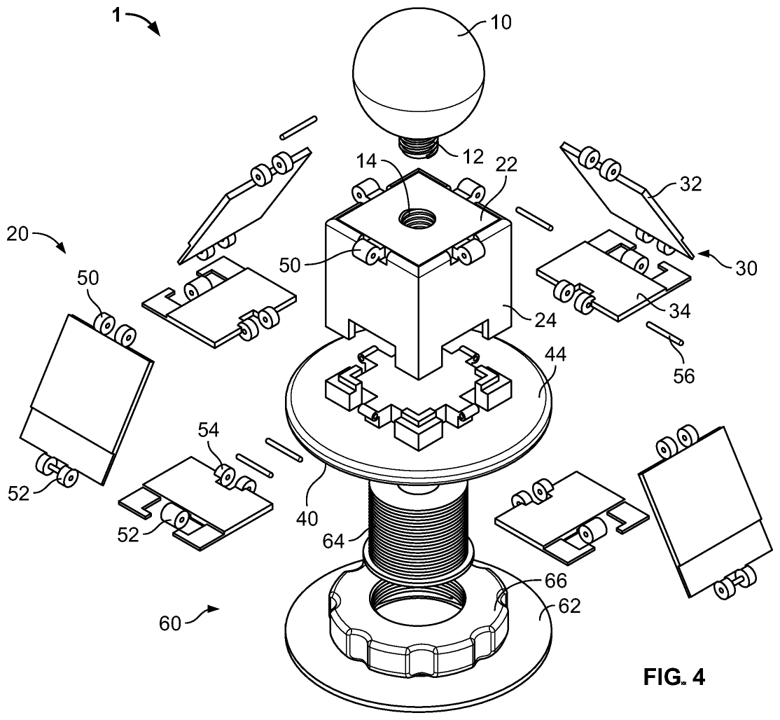

Referring to FIG. 4, an exploded view of the portable folding massage device is shown.

The portable foldable wall-mount massage device 1 is shown with massage element 10, including a threaded protrusion 12 that interfaces with threaded recess 14 of the frame 20—specifically the central column 22.

The central column 22 includes column legs 24 that interface with the base guides 42 of the base 40 when the portable foldable wall-mount massage device 1 is in its expanded position.

The base further includes a base ring 44 that provides a wider profile for support of the folding legs 30. The folding legs include an upper folding leg 32 and a lower folding leg 34, joined by upper hinge 50, middle hinge 52, and lower hinge 54. Each hinge 50/52/54 preferably includes a hinge pin 56, although hinges without hinge pins are anticipated.

The lower folding leg 34 optionally includes a lower folding leg foot 36 that in the expanded position rests against the base ring 44.

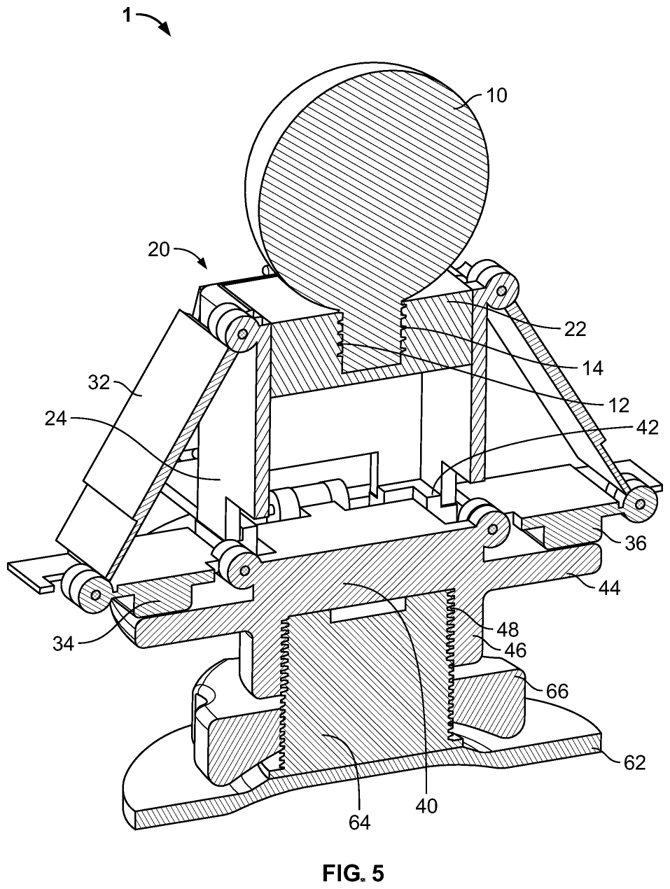

The base 40 includes a base protrusion 46 (see FIG. 5) through which passes the threaded base recess 48 (see FIG. 5), to which the suction cup assembly 60 attaches.

The suction cup assembly 60 includes a suction cup 62, suction cup threaded rod 64, and suction cup compression ring 66.

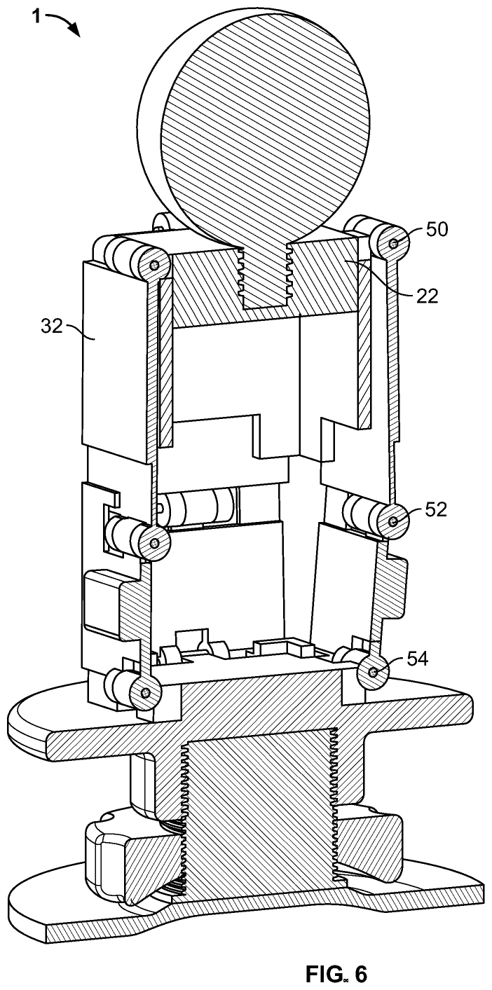

Referring to FIGS. 5 and 6, cross-sectional views of the expanded and collapsed states of the portable folding massage device are shown.

The portable foldable wall-mount massage device 1 is shown with massage element 10, and the associated threaded protrusion 12 interfaced with the threaded recess 14.

The frame 20 includes a central column 22 with column legs 24 that interface with the base guides 42. The folding legs 30 are preferably formed from an upper folding leg 32 and lower folding leg 34, the latter including an optional lower folding leg foot 36 that rests against the base ring 44 of the base 40 when the device is in its expanded position.

The folding legs 30 are made flexible by the upper hinge 50, middle hinge 52, and lower hinge 54, all optionally formed with hinge pins 56.

The base 40 is stabilized by the base protrusion 46 with threaded base recess 48.

The suction cup assembly 60 includes a suction cup 62, a suction cup threaded rod 64, and a suction cup compression ring 66.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A portable massage device with a folded position and an unfolded position, the portable massage device comprising:
a central column;
a massage element;
the massage element affixed to the central column;
one or more stabilizing legs;
the one or more stabilizing legs hingedly attached to the central column;
whereby the one or more stabilizing legs fold toward the central column to create a folded position, and fold away from the central column to create an unfolded position.

2. The portable massage device of claim 1, further comprising:
a base;
the one or more stabilizing legs connecting the central column to the base;
the central column in contact with the base in the unfolded position;
the central column separated from the base in the folded position;
whereby the base moves toward and away from the central column as the portable massage device changes position.

3. The portable massage device of claim 2, further comprising:
a suction cup;
the suction cup affixed to the base;
whereby the suction cup allows the portable massage device to be removably affixed to a surface.

4. The portable massage device of claim 3, further comprising:
a suction cup threaded rod;
the suction cup affixed to an end of the suction cup threaded rod;
a suction cup compression ring;
the suction cup compression ring threadedly interfaced with the suction cup threaded rod;
the suction cup compression ring acting to press against the suction cup, thereby increasing a gripping force of the suction cup.

5. The portable massage device of claim 1, further comprising:
a base ring;
the base ring partially supporting the one or more stabilizing legs when the portable massage device is in an unfolded position.

6. The portable massage device of claim 2, wherein:
the one or more stabilizing legs each includes an upper folding leg and a lower folding leg;
each upper folding leg connected the central column by an upper hinge;
each upper folding leg connects to each lower folding leg by a middle hinge;
each lower folding leg connected the base by a lower hinge;
whereby the middle hinge moves toward and away from the central column as the portable massage device folds and unfolds.

7. A massage device for removable mounting to a wall, the massage device comprising:
a central support;
a base;
one or more stabilizing legs;
the one or more stabilizing legs folding outward from the central support to rest against the base;
the one or more stabilizing legs folding inward toward the central support to create a narrower profile, the narrower profile easier to transport;
whereby the massage device for removable mounting to a wall is collapsible for transport.

8. The massage device for removable mounting to a wall of claim 7, wherein:
the one or more stabilizing legs connect the central support to the base;
the central support in contact with the base in an unfolded position;
the central support separated from the base in a folded position;
whereby the base moves toward and away from the central support as the massage device for removable mounting to a wall changes position.

9. The massage device for removable mounting to a wall of claim 8, further comprising:
a suction cup;
the suction cup affixed to the base;
whereby the suction cup allows the massage device for removable mounting to the wall to be removably affixed to a surface.

10. The massage device for removable mounting to a wall of claim 9, further comprising:
a suction cup threaded rod;
the suction cup affixed to an end of the suction cup threaded rod;
a suction cup compression ring;
the suction cup compression ring threadedly interfaced with the suction cup threaded rod;
the suction cup compression ring acting to press against the suction cup, thereby increasing a gripping force of the suction cup.

11. The massage device for removable mounting to a wall of claim 7, further comprising:
a base ring;
the base ring partially supporting the one or more stabilizing legs when the massage device for removable mounting to the wall is in an unfolded position.

12. The massage device for removable mounting to a wall of claim 8, wherein:
the one or more stabilizing legs each includes an upper folding leg and a lower folding leg;
each upper folding leg connected the central support by an upper hinge;
each upper folding leg connects to each lower folding leg by a middle hinge;
each lower folding leg connected the base by a lower hinge;
whereby the middle hinge moves toward and away from the central support as the massage device for removable mounting to a wall folds and unfolds.

13. A portable back massager that removably affixes to a wall, a profile of the portable back massager having a collapsed position for packing and an expanded position for use, the portable back massager comprising:
a base;
a massage element supported by a frame;
the frame including one or more folding legs;
the one or more folding legs acting to move the massage element toward and away from the base;
the collapsed position being with the massage element away from the base;
the expanded position being with the massage element toward the base;
whereby the portable back massager is moveable between the collapsed position and the expanded position as desired.

14. The portable back massager that removably affixes to a wall of claim 13, wherein:
the one or more folding legs connect the frame to the base;
the frame in contact with the base in an unfolded position;
the frame separated from the base in a folded position;
whereby the base moves toward and away from the frame as the portable back massager for removable mounting to a wall changes position.

15. The portable back massager that removably affixes to a wall of claim 14, further comprising:
a suction cup;
the suction cup affixed to the base;
whereby the suction cup allows the portable back massager that removably affixes to a wall to be removably affixed to a surface.

16. The portable back massager that removably affixes to a wall of claim 15, further comprising:
a suction cup threaded rod;
the suction cup affixed to an end of the suction cup threaded rod;
a suction cup compression ring;
the suction cup compression ring threadedly interfaced with the suction cup threaded rod;
the suction cup compression ring acting to press against the suction cup, thereby increasing a gripping force of the suction cup.

17. The portable back massager that removably affixes to a wall of claim 13, further comprising:
a base ring;
the base ring partially supporting the one or more folding legs when the portable back massager that removably affixes to a wall is in an unfolded position.

18. The portable back massager that removably affixes to a wall of claim 14, wherein:
the one or more folding legs each includes an upper folding leg and a lower folding leg;
each upper folding leg connected the frame by an upper hinge;
each upper folding leg connects to each lower folding leg by a middle hinge;
each lower folding leg connected the base by a lower hinge;
whereby the middle hinge moves toward and away from the frame as the portable back massager that removably affixes to a wall folds and unfolds.
